(19) United States
(12) Patent Application Publication
(10) Pub. No.: US 2025/0164912 A1
(43) Pub. Date: May 22, 2025

(54) HEATER, FIXING APPARATUS, AND IMAGE FORMING APPARATUS

(71) Applicant: CANON KABUSHIKI KAISHA, Tokyo (JP)

(72) Inventors: YUTAKA SATO, Tokyo (JP); KENICHI OGAWA, Kanagawa (JP)

(21) Appl. No.: 18/949,821

(22) Filed: Nov. 15, 2024

(30) Foreign Application Priority Data
Nov. 22, 2023 (JP) 2023-198090

(51) Int. Cl. G03G 15/20; G03G 15/00

(52) U.S. Cl. CPC G03G 15/2053; G03G 15/2039; G03G 15/2064; G03G 15/80; G03G 2215/2025

(57) ABSTRACT

A heater includes a substrate, at least one heat generation resistance element that is provided on the substrate and that extends in a longitudinal direction of the substrate, a power supply electrode that is provided on the substrate and that is configured to supply electric current to the at least one heat generation resistance element, an auxiliary layer that is provided to superpose only a partial region of the at least one heat generation resistance element and that has insulation property, and a protection layer that is layered on the auxiliary layer and provided to cover a whole region of the at least one heat generation resistance element and that is configured to protect the at least one heat generation resistance element.

### BACKGROUND

### Field

The present disclosure relates to a fixing apparatus including a heater, and an image forming apparatus.

### Description of the Related Art

An electrophotographic image forming apparatus includes a fixing apparatus that fixes toner to a sheet in a fixing nip portion formed between a fixing film and a pressure roller. Such a fixing apparatus rotates with the fixing film in contact with a heater, transmitting heat from the heater to the fixing film to fix toner to a sheet nipped in the fixing nip portion.

The heater disposed inside the fixing film includes a substrate, a heat generation resistance element, a conductive pattern, and a protection layer. The heat generation resistance element and the conductive pattern are provided on the substrate. The protection layer is used for protecting the heat generation resistance element and the conductive pattern. In such a heater, the thickness of the heat generation resistance element and that of the conductive pattern are approximately 10 μm in a thickness direction of the substrate, so that the protection layer has a uneven surface with a height difference of approximately 10 μm between the region in which the heat generation resistance element and the conductive pattern are provided and the region in which the heat generation resistance element and the conductive pattern are not provided. This results in a narrow region where the fixing film and the heater is in contact with each other (hereinafter referred to as an inner surface nip portion), which can cause low efficiency of heat transmission from the heater to the fixing film.

U.S. Patent Application Laid-Open No. 2019/0137913 discloses a configuration in which a convex portion is provided on a substrate with a space from a conductive pattern in order to smoothen the unevenness on the surface of a protection layer.

The configuration in which the convex portion is provided on the substrate with a space from a heat generation resistance element and the conductive pattern as disclosed in U.S. Patent Application Laid-Open No. 2019/0137913 has a concave surface of the protection layer at a position corresponding to the space.

### SUMMARY

According to an aspect of the present disclosure, a heater includes a substrate, at least one heat generation resistance element that is provided on the substrate and that extends in a longitudinal direction of the substrate, a power supply electrode that is provided on the substrate and that is configured to supply electric current to the at least one heat generation resistance element, an auxiliary layer that is provided to superpose only a partial region of the at least one heat generation resistance element and that has insulation property, and a protection layer that is layered on the auxiliary layer and provided to cover a whole region of the at least one heat generation resistance element and that is configured to protect the at least one heat generation resistance element.

Further features of the present disclosure will become apparent from the following description of exemplary embodiments with reference to the attached drawings.

### BRIEF DESCRIPTION OF THE DRAWINGS

FIG. 1 is a schematic configuration view of an image forming apparatus according to a first exemplary embodiment.

FIG. 2 is a cross-sectional view of a fixing apparatus according to the first exemplary embodiment.

FIG. 3 is an exploded perspective view of a film assembly unit used in the fixing apparatus according to the first exemplary embodiment.

FIG. 4 is a front view of the fixing apparatus according to the first exemplary embodiment.

FIG. 5A is a plan view of a heater according to the first exemplary embodiment.

FIG. 5B is a cross-sectional view of the heater according to the first exemplary embodiment.

FIG. 6A is a plan view of a heater according to a first comparative example. FIG. 6B is a cross-sectional view of the heater according to the first comparative example.

FIG. 7A is a plan view of a heater according to a second comparative example.

FIG. 7B is a cross-sectional view of the heater according to the second comparative example.

FIG. 8A is a plan view of a heater according to a second exemplary embodiment.

FIG. 8B is a cross-sectional view of the heater according to the second exemplary embodiment.

FIG. 9A is a plan view of a heater according to a third comparative example. FIG. 9B is a cross-sectional view of the heater according to the third comparative example.

FIG. 10A is a plan view of a heater according to a fourth comparative example.

FIG. 10B is a cross-sectional view of the heater according to the fourth comparative example.

FIG. 11A is a plan view of the heater according to a fifth comparative example.

FIG. 11B is a cross-sectional view of the heater according to the fifth comparative example.

### DESCRIPTION OF THE EMBODIMENTS

### (1) Image Forming Apparatus

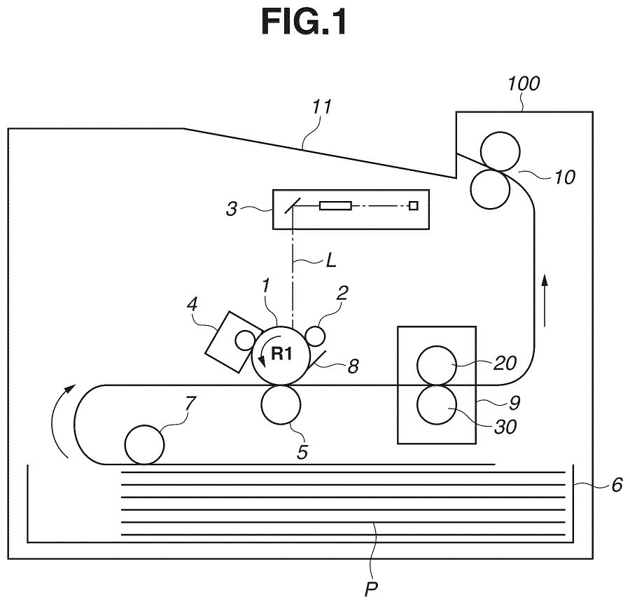

A first exemplary embodiment will be now described. A configuration and an operation of an image forming apparatus (laser printer) 100 using an electrophotographic process will be described with reference to FIG. 1. FIG. 1 is a cross-sectional view of the image forming apparatus 100. The image forming apparatus 100 includes a fixing apparatus 9 including a heater provided with heat generation resistance elements and a conductive pattern formed on the substrate of the heater as described below.

As illustrated in FIG. 1, a photosensitive drum 1, as one example of an image bearing member, is driven to be rotated in a direction of an arrow, and the surface of the photosensitive drum 1 is uniformly charged by a charging roller 2. The charged surface of the photosensitive drum 1 is scanned with a laser beam L based on image information by a laser scanner 3. This forms an electrostatic latent image on the surface of the photosensitive drum 1. The electrostatic latent image is developed with toner supplied from a developing device 4. The toner image formed on the photosensitive drum 1 is, in a transfer nip portion between a transfer roller 5 and the photosensitive drum 1, transferred to a recording material P fed in a conveyance direction of an arrow from a paper feed cassette 6. In the present exemplary embodiment, the photosensitive drum 1, the charging roller 2, the laser scanner 3, the developing device 4, and the transfer roller 5 are an example of an image forming unit.

The recording material P on which the toner image is transferred is conveyed to the fixing apparatus 9 where the toner image is fixed to the recording material P by heat. Thereafter, the recording material P is discharged onto a discharge tray 11. Residual toner on the photosensitive drum 1 after the transfer is collected by a cleaner 8.

The fixing apparatus 9 will be described in detail in item (2).

### (2) Fixing Apparatus 9

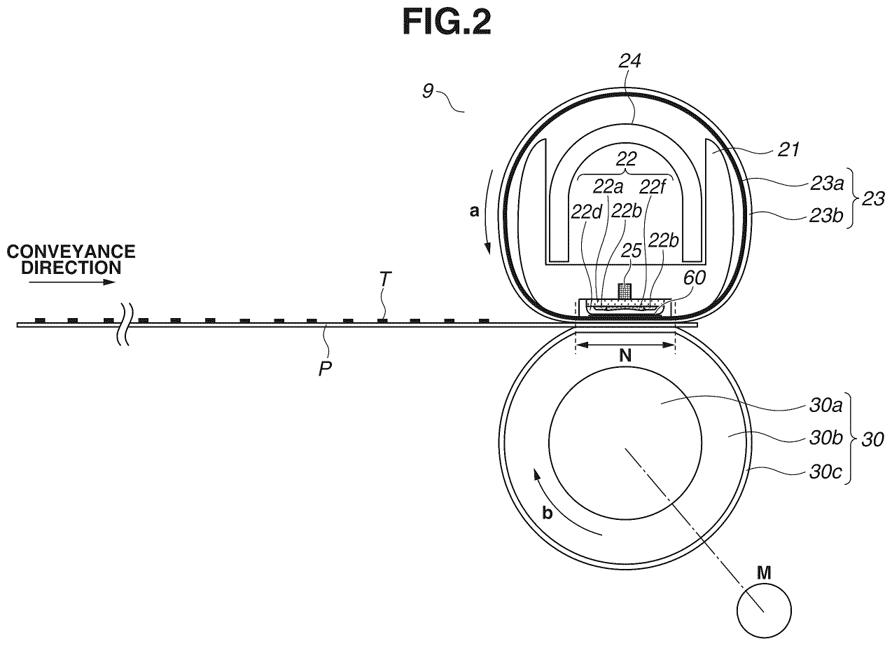

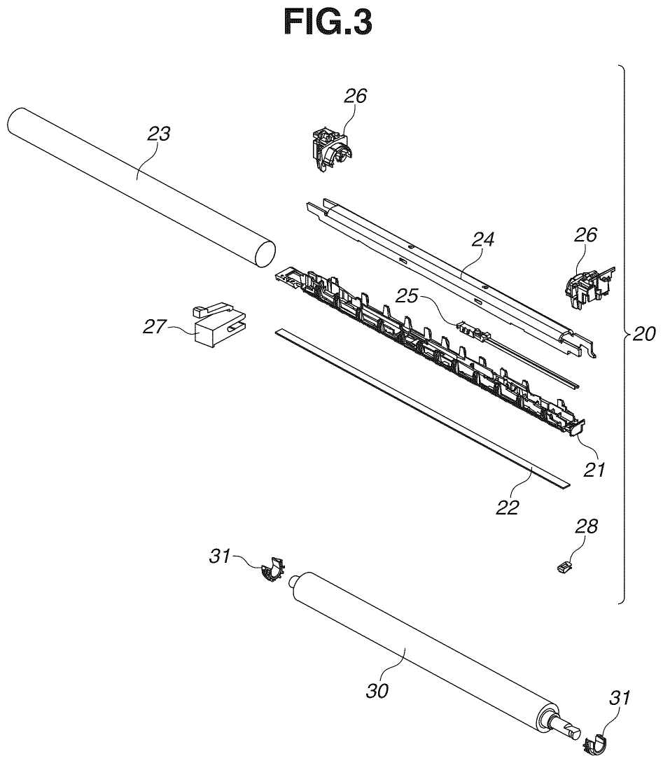

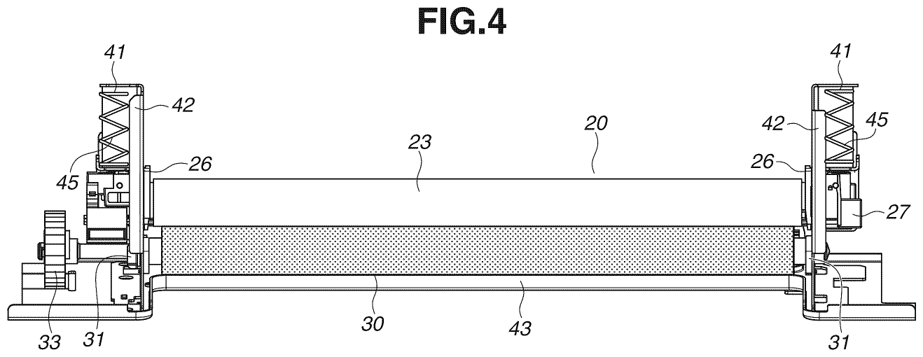

The fixing apparatus 9 mounted on the image forming apparatus 100 will now be described with reference to FIGS. 2 to 4. FIG. 2 is a schematic cross-sectional view of the fixing apparatus 9. FIG. 3 is an exploded perspective view of a film assembly unit 20 used in the fixing apparatus 9. FIG. 4 is a front view of the fixing apparatus 9.

The fixing apparatus 9 uses a tensionless-type film heating system. In the fixing apparatus 9 as a tensionless-type film heating system, a heat resistance film having an endless belt shape or a cylindrical shape is used. At least part of the circumferential length of the film is free of tension (in a state where tension is not applied), and the film is driven to be rotated by rotational drive force by a pressure member. Details of the fixing apparatus 9 as a film heating system will be described.

A configuration of the fixing apparatus 9 will now be described with reference to FIG. 2. The fixing apparatus 9 includes a film 23 having a cylindrical shape as an example of a first rotating body and a heater 22 as a heating member. Sliding grease 60 for increasing slidability on the heater 22 is applied to the inner surface of the film 23.

A reinforcing member 24 is made of metal, such as iron, and presses the heater 22 toward the pressure roller 30 via a film guide 21. The film guide 21 also has a guiding function for guiding the rotation of the film 23. The film guide 21 is, for example, a molded product of a heat-resistant resin, such as polyphenylene sulfide (PPS) or a liquid crystal polymer. In the present exemplary embodiment, PPS is used. The pressure roller 30 receives motive power from a motor M via a non-illustrated gear to be rotated in a direction of an arrow b. The film 23 is driven by the rotation of the pressure roller 30 to be rotated in a direction of an arrow a.

A substrate 22a of the heater 22 is made of ceramics. The heater 22 includes the substrate 22a having a long and narrow plate shape, heat generation resistance elements 22b that generate heat by energization, an auxiliary glass layer 22f provided between the heat generation resistance elements 22b and a protection layer 22d that protects the heat generation resistance elements 22b and the surface of the auxiliary glass layer 22f. A configuration of the heater 22 will be described in detail in item (3) below.

A thermistor 25, which is a temperature detection element, is in contact with one side of the substrate 22a out of contact with the film guide 21. The energization of the heat generation resistance elements 22b is controlled depending on a temperature detected by the thermistor 25.

The thickness of the film 23 is desirably 20 μm or more and 100 μm or less for favorable thermal conductivity. The film 23 can be a single layer film of a material, such as polytetrafluoroethylene (PTFE), perfluoroalkoxy alkane (PFA) (tetrafluoroethylene-perfluoro alkyl vinyl ether), or polyphenylene sulfide (PPS), as a film base layer 23a. Further, the film 23 is suitably also a composite layer film consisting of a separation layer 23b coated over one surface of a material of polyimide (PI), polyamide imide (PAI), polyether ether ketone (PEEK), or polyether sulfone (PES).

The separation layer 23b is suitably made of PTFE, PFA, or fluorinated ethylene propylene (FEP) (tetrafluoroethylene-perfluoro alkyl vinyl ether). Furthermore, a film suitably consists of a fluororesin tube covered on a separation layer coated, as above-mentioned, on a base layer. The base layer is made of a material of a pure metal having high thermal conductivity, such as steel use stainless (SUS), aluminum (Al), nickel (Ni), copper (Cu), or zinc (Zn), or an alloy thereof.

In the present exemplary embodiment, the film base layer 23a is made of PI with a thickness of 60 μm, and the separation layer 23b is coated with PFA with a thickness of 12 μm in consideration of both thermal conductivity and wear due to passing sheets through. The film 23 is 240 mm long.

The pressure roller 30 is an example of a pressure rotating body, and includes a core metal 30a made of steel or aluminum, an elastic layer 30b made of silicone rubber, and a separation layer 30c made of PFA.

The pressure roller 30 receives motive power from the motor M via the not-illustrated gear to be rotated in the direction of the arrow b. While the recording material P is being conveyed nipped through the fixing nip portion N, the toner image T on the recording material P is fixed to the recording material P by heat. The recording material P through the fixing nip portion N is conveyed to the discharge tray 11.

A description will be given with reference to an exploded perspective view in FIG. 3. As illustrated in FIG. 3, after the film guide 21 and the reinforcing member 24 are fitted to each other, the film 23 is fitted around the outer circumference of the film guide 21 and the reinforcing member 24 with an extra circumferential length. An axis direction of the cylindrical shape of the film 23 will be hereinafter referred to as a longitudinal direction.

flange members 26 are fitted to both the ends of the reinforcing member 24 protruding from both the ends of the film 23, assembling the film assembly unit 20 as a whole.

A power feeding connector 27 is fitted to a power supply terminal of the heater 22 also protruding from one end of the film 23. The power feeding connector 27 is in pressure contact with a power supply electrode 22h of the heater 22 to form a power supply path.

A heater clip 28 is formed of a metal plate curved in a substantially U-shape, providing springiness.

A description will be given with reference to a front view of FIG. 4. The flange members 26 restrict the movement in the longitudinal directions of the film 23 that rotationally travels, and restricts the position of the film 23 with the fixing apparatus 9 being in operation. The film assembly unit 20 is provided facing the pressure roller 30. The movement of the film assembly unit 20 in the right and left directions in FIG. 4 is restricted by frame side plates 42. The film assembly unit 20 is supported by top plate cases 41 of the fixing apparatus 9 so that the film assembly unit 20 can freely move in the up-and-down directions. Pressure springs 45 are compressedly attached to the respective top plate cases 41 of the fixing apparatus 9. The pressing forces of the pressure springs 45 are received by the two end portions of the reinforcing member 24 via the respective flange members 26, pressing the reinforcing member 24 toward the pressure roller 30, which presses the whole of the film assembly unit 20 toward the pressure roller 30.

Bearing members 31 are provided to rotatably support the core metal 30a of the pressure roller 30. The bearing members 31 receive pressing force from the film assembly unit 20 via the pressure roller 30. To rotatably support the core metal 30a of the pressure roller 30, which will have relatively high temperature, the material of the bearing members 31 has heat resistance and excellent slidability. The bearing members 31 are attached to a bottom case 43 of the fixing apparatus 9.

### (3) Heater 22

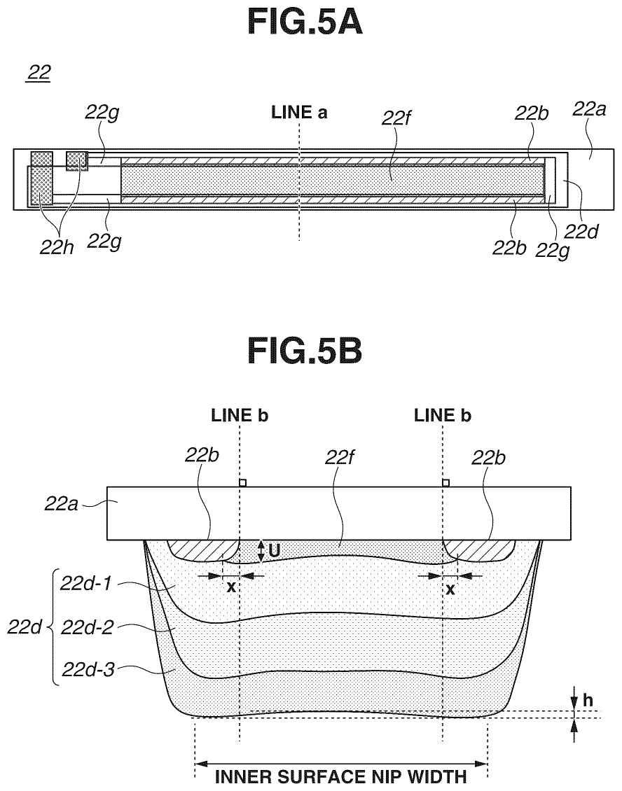

A configuration and manufacturing method for the heater 22 for the fixing apparatus 9 will now be described with reference to FIGS. 5A and 5B.

FIG. 5A is a plan view of the heater 22 in the longitudinal direction, and FIG. 5B is a cross-sectional view of the heater 22 in a width direction along a line as illustrated in FIG. 5A.

### (3-1) Substrate 22a

The heater 22 includes the substrate 22a made of ceramics. The type of ceramics is not particularly limited, and can be selected as appropriate in consideration of the mechanical strength, a linear expansion coefficient based on the formation of heat generation elements, the availability of the plate material in the market, and other factors.

The thickness of the substrate 22a can be determined in consideration of strength, heat capacity, and heat dissipation. If the substrate 22a is thin, the heat capacity is small, it is advantageous for quick start. If the substrate 22a is too thin, distortion is likely to occur in molding a heat generation element with heat. In contrast, if the substrate 22a is thick, it is advantageous in terms of prevention of distortion in molding a heat generation element with heat. However, if the substrate 22a is too thick, the heat capacity is large, whereby it is disadvantageous for quick start. The thickness of the substrate 22a is desirably 0.3 mm to 2.0 mm in consideration of the balance between manufacture, cost, and performance.

In the present exemplary embodiment, the substrate 22a prepared is an alumina substrate with a width of 6 mm, a length of 300 mm, and a thickness of 1 mm.

### (3-2) Heat Generation Resistance Element 22b

Each heat generation resistance element 22b is obtained through a calcination of the substrate 22a on which a heat generation resistance element paste composed of a mixture of (A) a conductive component, (B) a glass component, and (C) an organic binder component is printed in advance.

When each heat generation resistance element paste is calcined, (C) the organic binder component is burned away, and (A) the conductive component and (B) the glass component remain, forming each heat generation resistance element 22b containing the conductive component and the glass component is formed.

As (A) the conductive component, for example, a silver-palladium (Ag—Pd) alloy, ruthenium oxide (RuO₂), or a barium titanate (BaTiO₃) semiconductor is used alone or in combination. The sheet resistance value is desirably 0.1 [Ω/m²] to 100 [kΩ/m²).

In addition to the above-mentioned (A) to (C), another material can be added only if the amount thereof is small enough not to impair the characteristics of the present disclosure.

In the present exemplary embodiment, the heat generation resistance element paste used is a mixture of a silver-palladium (Ag—Pd) alloy as the conductive component in addition to the glass component and the organic binder component. After the heat generation resistance element paste is applied to the substrate 22a made of ceramics by screen printing, the substrate 22a is dried at 180° C. and calcined at 850° C., producing the heat generation resistance element 22b. The thickness of the heat generation resistance elements 22b after the calcination is 10 μm, the length thereof is 220 mm, and the width thereof is 0.9 mm. As illustrated in FIG. 5B, two heat generation resistance elements 22b are formed with an interval of 2.8 mm.

### (3-3) Power Supply Electrode 22h and Conductive Pattern 22g

The power supply electrode 22h and a conductive pattern 22g illustrated in FIG. 5A contains silver (Ag), platinum (Pt), gold (Au), a silver-platinum (Ag—Pt) alloy, a silver-palladium (Ag—Pd) alloy, or another substance as a main component. The power supply electrode 22h and the conductive pattern 22g are obtained through the calcination of the substrate 22a on which a paste as a mixture of (A) a conductive component, (B) a glass component, and (C) an organic binder component is printed in advance, similarly to the heat generation resistance element paste.

The power supply electrode 22h and the conductive pattern 22g are provided for the purpose of supplying an electric current and a voltage to the heat generation resistance elements 22b, and the resistance to the heat generation resistance elements 22b is made sufficiently low.

As materials of the heat generation resistance element paste and the paste for the power supply electrode 22h and the conductive pattern 22g, which have been described above, materials are selected that softens and melts at a temperature lower than the melting point of the substrate 22a and that have heat resistance in consideration of the temperatures for practical use.

In the present exemplary embodiment, the paste for the power supply electrode 22h and the conductive pattern 22g is prepared as a mixture of silver as the conductive component in addition to the glass component and the organic binder component. After the paste is applied to the substrate 22a made of ceramics by screen printing, the substrate 22a is dried at 180° C. and calcined at 850° C., producing the power supply electrode 22h and the conductive pattern 22g.

### (3-4) Protection Layer 22d

The protection layer 22d illustrated in FIGS. 5A and 5B is provided to cover the heat generation resistance elements 22b and the conductive pattern 22g for the purpose of protecting the heat generation resistance elements 22b and the conductive pattern 22g. The protection layer 22d covers the whole region of the heat generation resistance elements 22b, unlike an auxiliary glass layer 22f, which will be described below. The material of the protection layer 22d is desirably glass or polyimide (PI) in terms of heat resistance, and a heat transfer filler having insulation property can be mixed, as appropriate. In the present exemplary embodiment, glass is used as the material of the protection layer 22d. After a glass paste is applied by screen printing, the glass paste is dried at 180° C. and calcined at 850° C., producing the protection layer 22d. The protection layer 22d can have a defect, such as a through-hole and foreign matter, at the time of printing, drying, and calcination. To prevent reduction of the withstanding voltage of the protection layer 22d, the protection layer 22d desirably consists of a plurality of layers. In the present exemplary embodiment, as illustrated in FIG. 5B, the protection layer 22d consists of three layers.

In the present exemplary embodiment, in order to make flatter the uneven surface of the protection layer 22d, the auxiliary glass layer 22f is provided to fill the space between the two heat generation resistance elements 22b before the formation of the protection layer 22d. The auxiliary glass layer 22f intersects lines b drawn at both ends of the heat generation resistance elements 22b in a direction perpendicular to the substrate 22a made of ceramics, and parts of the auxiliary glass layer 22f overlaps the heat generation resistance elements 22b. A length x of the superposition in the present exemplary embodiment is 100 μm. The film thickness of the auxiliary glass layer 22f indicated by an arrow U is 10 μm, which is substantially identical to the film thickness of the heat generation resistance elements 22b. Around and in the regions in which the auxiliary glass layer 22f and the heat generation resistance element 22b overlap with each other, the auxiliary glass layer 22f is laminated on the heat generation resistance elements 22b, so that the auxiliary glass layer 22f is laminated up to a level that is a little thicker than indicated by the arrow U. At a middle portion in the width direction (the left and right direction in FIG. 5B) of the substrate 22a, the auxiliary glass layer 22f tends to be slightly thinner than indicated by the arrow U due to the adhesion between the auxiliary glass layer 22f and the substrate 22a.

As illustrated in FIG. 5A, the auxiliary glass layer 22f is 220 mm long, which is identical to the length of the heat generation resistance elements 22b.

The auxiliary glass layer 22f uses a glass paste of the same type as that of the protection layer 22d. The protection layer glass paste is applied by screen printing to overlap the region of the heat generation resistance elements 22b as described above, and thereafter dried at 180° C. and calcined at 850° C., producing the auxiliary glass layer 22f. Thereafter, through similar processes of printing, drying, and calcination, protection layers 22d-1, 22d-2, and 22d-3 are sequentially produced.

The auxiliary glass layer 22f is an example of an auxiliary layer in the present exemplary embodiment, and a material other than glass can be used for the auxiliary glass layer 22f similarly to that of the protection layer 22d. In this case, polyimide (PI) is desirably used in terms of heat resistance. However, a heat transfer filler with insulation property can be mixed as appropriate.

In the following, configurations of other examples and those of comparative examples will be described, and actions and effects will be finally described as a summary. The configurations regarding an image forming apparatus and a fixing apparatus other than the heater 22 in each of the other examples and comparative examples are similar to the configurations according to the first exemplary embodiment, and thus a description thereof is omitted.

### Comparative Example 1

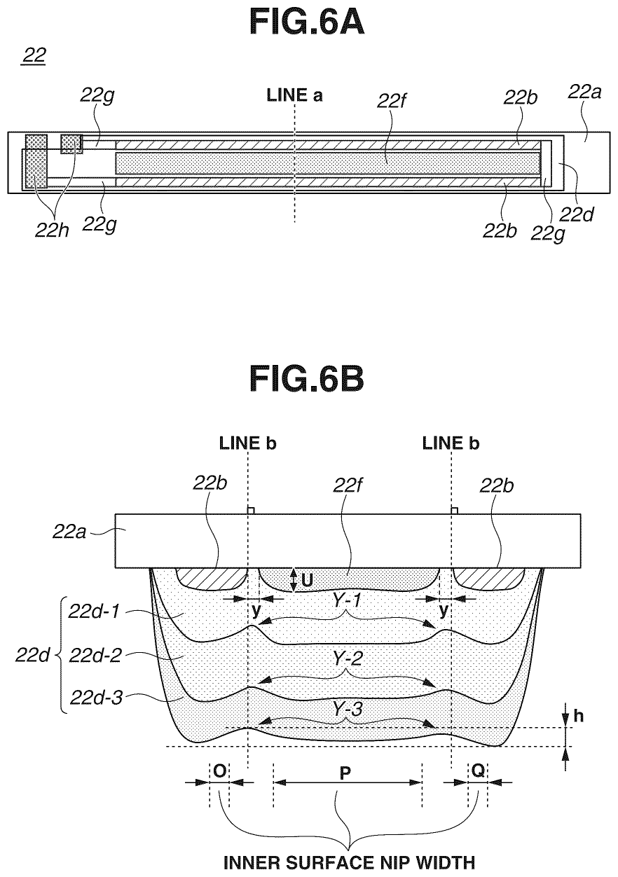

FIG. 6A is a plan view of a heater 22 in the longitudinal direction according to a first comparative example, and FIG. 6B is a cross-sectional view of the heater 22 in the width direction along the line a as illustrated in FIG. 6A. Unlike the heater 22 according to the first exemplary embodiment, the auxiliary glass layer 22f is provided with a space y from each heat generation resistance element 22b.

The space y in the present comparative example is 100 μm. The other parameters are identical to those in the first exemplary embodiment.

### Comparative Example 2

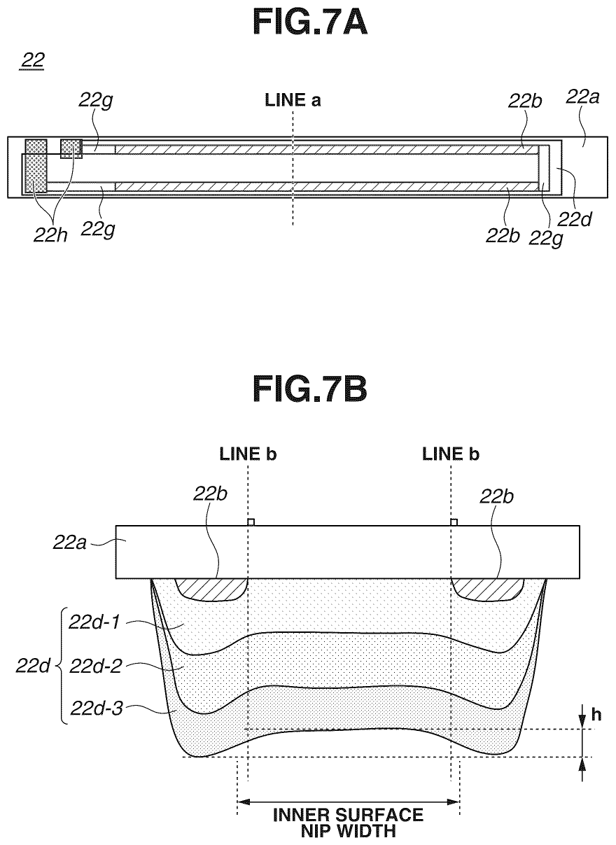

FIG. 7A is a plan view of a heater 22 in the longitudinal direction according to a second comparative example, and FIG. 7B is a cross-sectional view of the heater 22 in the width direction along the line a as illustrated in FIG. 7A. The heater according to the present comparative example is characterized by the absence of the auxiliary glass layer 22f, unlike the heater 22 according to the first exemplary embodiment and that according to the first comparative example. The other parameters are identical to those in the first exemplary embodiment.

### Exemplary Embodiment 2

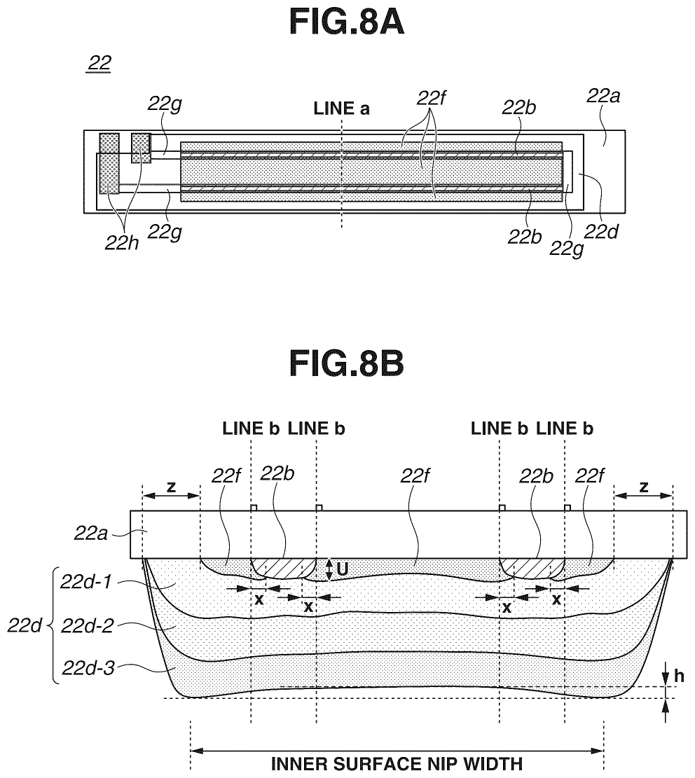

FIG. 8A is a plan view of a heater 22 in the longitudinal direction according to a second exemplary embodiment, and FIG. 8B is a cross-sectional view of the heater 22 in the width direction along the line a as illustrated in FIG. 8A.

In the heater 22 according to the present exemplary embodiment, a substrate 22a has a width larger than that of the substrate 22a according to the first exemplary embodiment as illustrated in FIGS. 8A and 8B. The substrate 22a in the second exemplary embodiment is 8 mm wide, 300 mm long, and 1 mm thick. The substrate 22a in the second exemplary embodiment is made of alumina, which is identical to that in the first exemplary embodiment. The heat generation resistance elements 22b each have a thickness and a size that are identical to those in the first exemplary embodiment, and the interval between the two heat generation resistance elements 22b is 2.8 mm, which is also identical to that in the first exemplary embodiment.

In the second exemplary embodiment, the auxiliary glass layer 22f is provided to fill the space between the two heat generation resistance elements 22b, which is identical to the case of the first exemplary embodiment, and additional auxiliary glass layers 22f are provided in directions of both ends of the heater 22 in the width directions. In the present exemplary embodiment, all the auxiliary glass layers 22f overlap the heat generation resistance elements 22b by a length of 100 μm. The length x of the superposition is not necessarily identical, and can be set to an optimal value as appropriate depending on the shape of the protection layer 22d. As illustrated in FIG. 8B, each auxiliary glass layer 22f at the farthest portion of the heater 22 in the width direction and the protection layer 22d are provided with a distance z=0.6 mm as the space between.

### Comparative Example 3

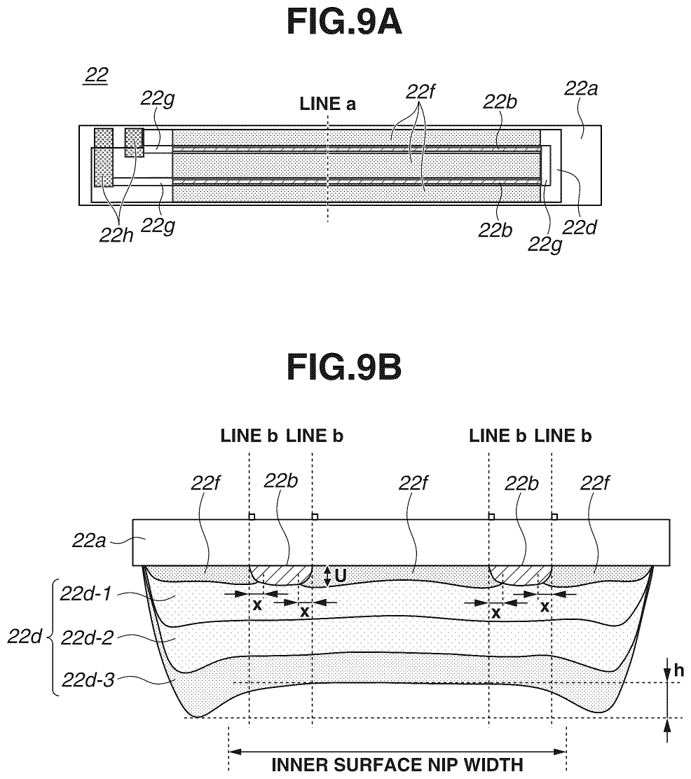

FIG. 9A is a plan view of a heater 22 in the longitudinal direction according to a third comparative example, and FIG. 9B is a cross-sectional view of the heater 22 in the width direction along the line a as illustrated in FIG. 9A.

As illustrated in FIG. 9B, the present comparative example is characterized in that each auxiliary glass layer 22f at the farthest portion of the heater 22 in the width direction and the protection layer 22d are provided without a distance as the space between them. The other parameters are identical to those in the second exemplary embodiment.

### Comparative Example 4

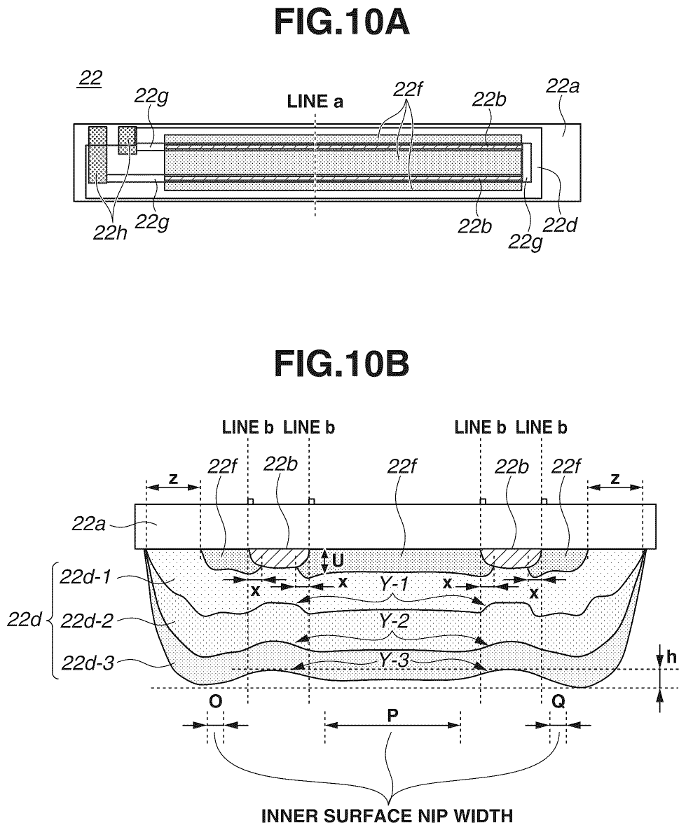

FIG. 10A is a plan view of a heater 22 in the longitudinal direction according to a fourth comparative example, and FIG. 10B is a cross-sectional view of the heater 22 in the width direction along the line a as illustrated in FIG. 10A.

As illustrated in FIG. 10B, the present comparative example is characterized in that an auxiliary glass layer 22f has a thickness of 15 μm, which is larger than 10 μm in the first and second exemplary embodiments. The other parameters are identical to those in the second exemplary embodiment.

### Comparative Example 5

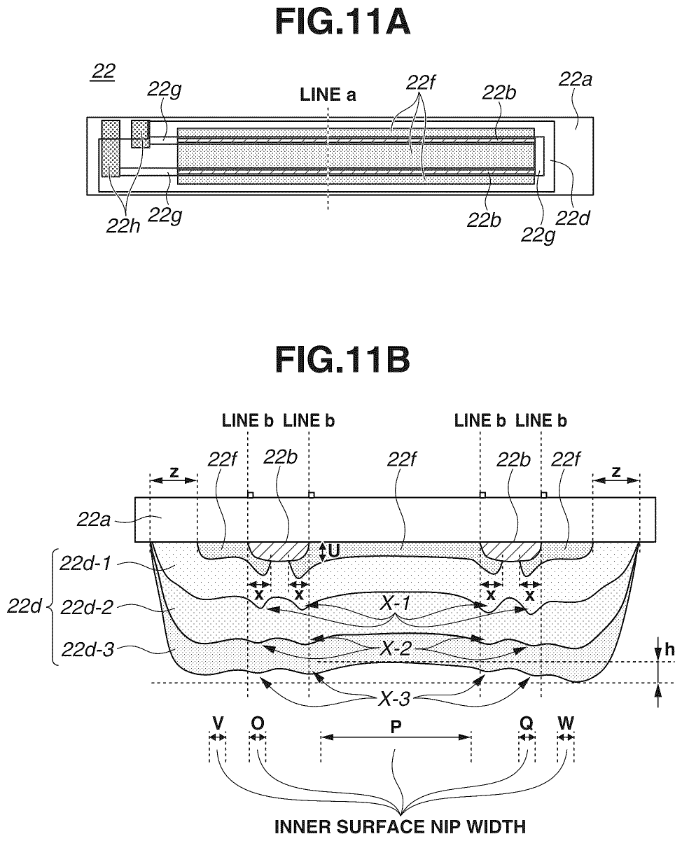

FIG. 11A is a plan view of a heater 22 in the longitudinal direction according to a fifth comparative example, and FIG. 11B is a cross-sectional view of the heater 22 in the width direction along the line a as illustrated in FIG. 11A.

As illustrated in FIG. 11B, the present example is characterized in that all the auxiliary glass layers 22f overlap the heat generation resistance elements 22b by the length x 300 μm. The other parameters are identical to those in the second exemplary embodiment.

### (4) Actions and Effects

<Surface Shape of Protection Layer 22d>

Regarding the heaters 22 according to the first and second exemplary embodiments and the first to fifth comparative examples, which have been described above, the uneven shape of the protection layer 22d-3 as the outermost surface of each protection layer 22d was observed.

In the heater 22 according to the first exemplary embodiment, as illustrated in FIG. 5B, the auxiliary glass layer 22f that was provided smoothed the uneven shape of the surface of the protection layer 22d-3. The difference in height h of the uneven shape of the surface of the protection layer 22d-3 was 1 μm or less. That is, the configuration of the heater 22 according to the first exemplary embodiment allows the difference in height in the surface of the protection layer 22d-3 to be 1 μm or less.

In the heater 22 according to the first comparative example, as illustrated in FIG. 6B, the region as the space y that exists caused concave shapes Y-1, Y-2, and Y-3 of the surfaces of the protection layers 22d-1, 22d-2, and 22d-3, respectively. The uneven shapes of the surfaces tended to be gradually leveled every time the protection layer 22d was layered, and the unevenness of the concave shape Y-3 was made close to flat in comparison with that of the concave shape Y-1. However, due to two concave shapes Y-3 formed in the surface of the protection layer 22d-3, the difference in height h of the uneven shape of the protection layer 22d-3 was approximately 10 μm.

In the heater 22 according to the second comparative example, as illustrated in FIG. 7B, as the uneven shapes of the surface of the protection layer 22d-3, both the end portions of the heater 22 in the width direction had convex shapes and the middle portion of the heater 22 had a concave shape. There are two conceivable reasons. One reason is that the protection layer 22d on the heat generation resistance elements 22b rises due to the heat generation resistance elements 22b provided at both the two end portions of the heater 22 in the width direction. The other reason is that, when the glass paste was applied by screen printing, surface tension acted on both the two ends of the heater 22 in the width direction within the glass paste film, causing a phenomenon in which the glass paste film at both the two ends of the heater 22 in the width direction was thicker than the middle portion. This phenomenon is called a saddle phenomenon. For these two reasons, the difference in height h of the uneven shape of the protection layer 22d-3 in the present comparative example became as large as approximately 15 μm.

In the heater 22 according to the second exemplary embodiment, as illustrated in FIG. 8B, the auxiliary glass layer 22f also provided in the heater 22 using the substrate 22a having a large width smoothed the uneven shape of the surface of the protection layer 22d-3. The difference in height h of the uneven shapes of the surface of the protection layer 22d-3 was approximately 1 μm. The reason for the auxiliary glass layer 22f at the farthest portions of the heater 22 in the width direction and the protection layer 22d provided with the distance z=0.6 mm as the space between them is that the above-mentioned saddle phenomenon occurs at the time of printing the protection layer 22d. That is, this is because of avoiding the formation of a large convex shape due to the overlap of the convex shape caused by the saddle phenomenon and the convex shape of the auxiliary glass layer 22f.

In the heater 22 according to the third comparative example, as illustrated in FIG. 9B, the auxiliary glass layer 22f at the farthest portion of the heater 22 in the width direction and the protection layer 22d provided without a distance as the space between them caused the convex shapes caused by the saddle phenomenon and the convex shapes of the auxiliary glass layer 22f to overlap with each other. The resulting difference in height h of the uneven shape of the protection layer 22d-3 became as large as approximately 12 μm.

In the heater 22 according to the fourth comparative example, as illustrated in FIG. 10B, the auxiliary glass layer 22f had a thickness of 15 μm, which was larger than the thickness (10 μm) of the heat generation resistance element 22b, causing the convex shapes of the protection layer 22d. As a result, due to the two concave shapes Y-3 formed on the surface of the protection layer 22d-3, the difference in height h of the uneven shape of the protection layer 22d-3 was approximately 5 μm.

In the heater 22 according to the fifth comparative example, as illustrated in FIG. 11B, the length x of the superposition between the auxiliary glass layer 22f and the heat generation resistance elements 22b was 300 μm, causing the auxiliary glass layer 22f in the superposition regions to have a convex shape with a small width. As a result, convex shapes X-1, X-2, and X-3 were formed in the protection layers 22d-1, 22d-2, and 22d-3, respectively. The resulting difference in height h of the uneven shape of the protection layer 22d-3 was approximately 5 μm.

### (Measurement of Inner Surface Nip)

Each of the heaters 22 according to the first and second exemplary embodiments and the first to fifth comparative examples was added to the fixing apparatus 9 and the inner surface nip was checked.

In the heater 22 according to the first exemplary embodiment, as illustrated in FIG. 5B, the uneven shape of the surface of the protection layer 22d-3 was smooth, so that the width of the inner surface nip (hereinafter referred to as an inner surface nip width) was obtained in a large portion of the surface of the protection layer 22d-3. As a result, the inner surface nip width was 4.5 mm.

In the heater 22 according to the first comparative example, as illustrated in FIG. 6B, the inner surface nip portion was divided into three regions indicated by O, P, and Q due to the two concave shapes Y-3 formed on the surface of the protection layer 22d-3.

The total of these three inner surface nip widths was 3.4 mm.

In the heater 22 according to the second comparative example, as illustrated in FIG. 7B, the inner surface nip width was restricted due to the large convex shapes at the two end portions of the protection layer 22d-3 in the width direction. As a result, the inner surface nip width was as narrow as 3.0 mm.

In the heater 22 according to the second exemplary embodiment, as illustrated in FIG. 8B, the inner surface nip width was obtained in a large portion of the surface of the protection layer 22d-3. As a result, the inner surface nip width was 6.5 mm, which was a larger inner surface nip width than any of those in the first exemplary embodiment and the first to fifth comparative examples.

In the heater 22 according to the third comparative example, as illustrated in FIG. 9B, the inner surface nip width was restricted due to the large convex shapes at the two end portions of the protection layer 22d-3 in the width direction. As a result, the inner surface nip width was 5.0 mm, which was narrower than that in the second exemplary embodiment.

In the heater 22 according to the fourth comparative example, as illustrated in FIG. 10B, the inner surface nip portion was divided into the three regions indicated by O, P, and Q due to the two concave shapes Y-3 formed on the surface of the protection layer 22d-3. The total of these three inner surface nip widths was 3.8 mm.

In the heater 22 according to the fifth comparative example, as illustrated in FIG. 11B, the inner surface nip portion was divided into five regions indicated by O, P, Q, V, and W due to the four concave shapes X-3 of the surface of the protection layer 22d-3. The total of these five inner surface nip widths was 4.0 mm.

### (Evaluation of Fixability)

Each of the heaters 22 according to the first and second exemplary embodiments and the first to fifth comparative examples was added to the fixing apparatus 9. While the image forming apparatus 100 was operated at a circumferential speed of the pressure roller 30 of 250 mm/s, the fixability of toner images on recording materials was evaluated. At this time, the detection temperatures (adjusted temperature) of the thermistor 25 were set at several steps, and an adjusted temperature providing favorable fixability was checked.

The above-mentioned inner surface nip widths and adjusted temperatures providing favorable fixability are listed on Table 1.

TABLE 1

| | | Adjusted temperature | |
|---|---|---|---|
| | Internal surface | providing favorable | Deformation of |
| | nip width | fixability | film guide 21 |
| First | 4.5 mm | 227° C. | None |
| exemplary | | | |
| embodiment | | | |
| First | 3.4 mm | 240° C. | Occurred |
| comparative | | | |
| example | | | |
| Second | 3.0 mm | 245° C. | Occurred |
| comparative | | | |
| example | | | |
| Second | 6.5 mm | 205° C. | None |
| exemplary | | | |
| embodiment | | | |
| Third | 5.0 mm | 221° C. | None |
| comparative | | | |
| example | | | |
| Fourth | 3.8 mm | 235° C. | Occurred |
| comparative | | | |
| example | | | |
| Fifth | 4.0 mm | 233° C. | Occurred |
| comparative | | | |
| example | | | |

As indicated on Table 1, it is found that there is a correlation between the inner surface nip width and the adjusted temperature providing favorable fixability, and a larger inner surface nip width results in a lower adjusted temperature providing favorable fixability. This is because a larger inner surface nip width provides an increased efficiency of heat transmission to the film 23, which eliminates the need for excessively heating the heater 22.

On the other hand, with a higher adjusted temperature of the heater 22, the heat resistance temperature of the film guide 21 that holds the heater 22 and deformation of the film guide 21 due to heat should be paid attention to. The deformation of the film guide 21 is also described on Table 1. It was found that through continuous use of the image forming apparatus 100 at an adjusted temperature providing favorable fixability, with the adjusted temperature being as high as over 233° C., the contact surface between the heater 22 and the film guide 21 was deformed. A conceivable reason for the deformation is that, in addition to the condition of the high temperature, strong pressing force is applied to the contact surface between the heater 22 and the film guide 21. The deformation of the film guide 21 can lead to uneven pressing force, an uneven fixing nip portion N, and an uneven inner surface nip width, causing a fixability defect or a defect in conveyance of a recording material.

As indicated on Table 1, with the configurations of the first and second exemplary embodiments and the third comparative example, the adjusted temperatures providing favorable fixability were low, with a favorable result of no deformation of the film guide 21. However, with the image forming apparatus 100 including the pressure roller 30 whose circumference speed is further accelerated, the fixing temperature would be set to a higher temperature, so that a configuration having a very large inner surface nip width like that in the second exemplary embodiment would be desirable.

As described above, in the second exemplary embodiment, the distance between the auxiliary glass layer 22f at the farthest portions of the heater 22 in the width direction and the protection layer 22d is 0.6 mm. However, the distance can be changed as appropriate depending on the position of the heat generation resistance elements 22b disposed on the substrate 22a, the thickness of the protection layer 22d, or other factors. In the present exemplary embodiment, z≥0.5 mm is desirably satisfied.

The ratio of (the thickness of the auxiliary glass layer 22f)/(the thickness of the heat generation resistance elements 22b) is desirably in the range between 80% and 120%, and more desirably 100% like that in the first and second exemplary embodiments.

It was found that, regarding the length x of the superposition between the auxiliary glass layer 22f and the heat generation resistance elements 22b, the configuration with 100 μm as the length x in the second exemplary embodiment achieved a more favorable evaluation result. While the optimal value of the length x of the superposition is influenced by the cross-section of the auxiliary glass layer 22f and that of the heat generation resistance elements 22b, the value is desirably 200 μm or less.

While the description has been given of the configuration in which the auxiliary glass layer 22f overlaps the heat generation resistance elements 22b as the exemplary embodiments, a similar effect can be produced with the auxiliary glass layer 22f overlapping the conductive pattern like the prior art.

While the description has been given of the increase of the inner surface nip width by smoothing of the surface of the protection layer 22d in the present exemplary embodiments, other advantageous effects can be produced. For example, the film 23 is driven to be rotated by rotational drive force of the pressure roller 30, so that a reduced uneven shape of the protection layer 22d that slides on the inner surface of the film 23 can facilitate the rotation of the film 23. As a result, when the recording material P passes the fixing nip portion N, the differences in speed between the film 23, the pressure roller 30, and the recording material P are reduced, reducing the abrasion of the surface of the film 23 by the end portions of the recording material P.

According to the present exemplary embodiments, the following effects can be produced. That is, the arrangement of the auxiliary glass layer 22f smooths the uneven surface of the protection layer 22d. This provides a larger inner surface nip, increasing the efficiency of heat transfer from the heater to the fixing film. A toner image on the recording material can be fixed to the recording material by heat in a favorable state.

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-198090, filed Nov. 22, 2023, which is hereby incorporated by reference herein in its entirety.

What is claimed is:

1. A heater comprising:
a substrate;
at least one heat generation resistance element that is provided on the substrate and that extends in a longitudinal direction of the substrate;
a power supply electrode that is provided on the substrate and that is configured to supply electric current to the at least one heat generation resistance element;
an auxiliary layer that is provided to superpose only a partial region of the at least one heat generation resistance element and that has insulation property; and
a protection layer that is layered on the auxiliary layer and provided to cover a whole region of the at least one heat generation resistance element and that is configured to protect the at least one heat generation resistance element.

2. The heater according to claim 1, wherein the protection layer is provided in a region of the substrate, the region excluding the power supply electrode.

3. The heater according to claim 1,
wherein the at least one heat generation resistance element comprises two heat generation resistance elements, and
wherein the auxiliary layer is provided so as to fill a space between the two heat generation resistance elements.

4. The heater according to claim 1, wherein the at least one heat generation resistance element and the auxiliary layer superpose each other in a width direction of the heater, and a length of a region of the superposition in the width direction is 200 μm or less.

5. The heater according to claim 1, wherein a difference in height in a surface of the protection layer is 1 μm or less.

6. The heater according to claim 1, wherein an end portion of the auxiliary layer and an end portion of the protection layer in a width direction of the heater are provided with a distance as a space between the end portions.

7. The heater according to claim 1, wherein the auxiliary layer is made of glass.

8. The heater according to claim 1, wherein the protection layer includes a plurality of layers.

9. The heater according to claim 1, wherein a ratio of a thickness of the auxiliary layer to a thickness of the at least one heat generation resistance element is 120% or less.

10. The heater according to claim 1,
wherein the at least one heat generation resistance element extends in a longitudinal direction of the heater, and
wherein a length of the heater in a width direction in a region in which the at least one heat generation resistance element and the auxiliary layer superpose each other is 200 μm or less.

11. The heater according to claim 1, further comprising a conductive pattern configured to supply electric current from the power supply electrode to the at least one heat generation resistance element.

12. A fixing apparatus comprising:
a substrate;
at least one heat generation resistance element that is provided on the substrate and that extends in a longitudinal direction of the substrate;
a power supply electrode that is provided on the substrate and that is configured to supply electric current to the at least one heat generation resistance element;
an auxiliary layer that is provided to superpose only a partial region of the at least one heat generation resistance element and that has insulation property; and
a protection layer that is layered on the auxiliary layer and provided to cover a whole region of the at least one heat generation resistance element and that is configured to protect the at least one heat generation resistance element;
a first rotating body configured to be heated by the heat generation resistance element; and
a second rotating body configured to form, together with a fixing film, a nip portion,
wherein the fixing apparatus is configured to fix a toner image formed on a recording material by heat.

13. The fixing apparatus according to claim 12, wherein the first rotating body is a fixing film.

14. The fixing apparatus according to claim 13, wherein the heater is provided in contact with an inner surface of the fixing film, and the nip portion is formed by the heater and the second rotating body via the fixing film.

15. An image forming apparatus comprising:
an image forming unit configured to form a toner image on a recording material; and
a fixing apparatus
wherein the fixing apparatus comprises:
a substrate;
at least one heat generation resistance element that is provided on the substrate and that extends in a longitudinal direction of the substrate;
a power supply electrode that is provided on the substrate and that is configured to supply electric current to the at least one heat generation resistance element;
an auxiliary layer that is provided to superpose only a partial region of the at least one heat generation resistance element and that has insulation property; and
a protection layer that is layered on the auxiliary layer and provided to cover a whole region of the at least one heat generation resistance element and that is configured to protect the at least one heat generation resistance element;
a first rotating body configured to be heated by the heat generation resistance element; and
a second rotating body configured to form, together with a fixing film, a nip portion,
wherein the fixing apparatus is configured to fix a toner image formed by the image forming unit.
